(19) United States
(12) Patent Application Publication
(10) Pub. No.: US 2009/0061886 A1
(43) Pub. Date: Mar. 5, 2009

(54) System and Method for Activity-Based Power Control Target Adjustments in a Wireless Communication Network

(76) Inventors: Carmela Cozzo, Cary, NC (US); Christer Edholm, Taby (SE); Hakan Eriksson, Taby (SE)

Correspondence Address: COATS & BENNETT, PLLC, 1400 Crescent Green, Suite 300, Cary, NC, 27518, US

(21) Appl. No.: 11/846,773

(22) Filed: Aug. 29, 2007

(51) Int. Cl. H04Q 7/20; H04M 1/00

(52) U.S. Cl. 455/450; 455/561

(57) ABSTRACT

The teachings presented herein provide, among other things, improved power control stability and increased system capacity in a wireless communication network by raising signal quality targets for mobile stations engaged in scheduled uplink data transmissions and lowering those signal quality targets at the end of such transmissions. As one example, the teachings herein are applied to the Enhanced Uplink (EUL) in a Wideband CDMA (WCDMA) network. In that context, the target received signal quality (e.g., SIR) for a given mobile station's Dedicated Physical Control Channel (DPCCH) signal is raised for times when the mobile station is engaged in a scheduled data transmission via its Enhanced-Dedicated Physical Data Channel (E-DPDCH), and lowered at other times. Doing so prevents the power control loop from “chasing” the potentially dramatic changes in mobile-specific interference conditions that arise in a scheduled uplink environment.

### BACKGROUND

1. Technical Field

The present invention generally relates to communication link power control in wireless communication networks, and particularly relates to activity-based adjustment of a power control target used in such systems.

### Background

Maximizing link capacity represents an important aspect of advancing the performance of wireless communication systems. The link scheduling provisions in developing standards, such as the Enhanced Uplink (EUL) provisions of the Wideband Code Division Multiple Access (WCDMA) in Releases 6 and 7 of the Third Generation Partnership Project (3GPP) standard, reflect this aspect of wireless communication evolution. Other standards similarly define scheduled transmission environments, such as the CDMA2000 standards, and selected Wireless Local Area Networking (WLAN) standards.

Uplink (also referred to as “reverse link”) scheduling within a given radio coverage area, e.g., cell or sector, permits one or a constrained number of users to transmit uplink data (traffic) in any given scheduling interval. Allowing only one user, for example, to transmit uplink data in any given scheduling interval prevents other user's uplink data transmissions from interfering with the scheduled user's data transmission, and effectively devotes the available uplink capacity to that user. Doing so maximizes the uplink data rate achievable by the scheduled user.

Of course, scheduling may be more sophisticated, such as by scheduling multiple users in the same interval, but perhaps with only one or two high-rate users permitted. Further, any given user may be permitted to transmit at essentially any time on an unscheduled basis, but these types of unscheduled transmissions may be constrained to a low data rate, for example. Consequently, unscheduled transmissions of this type, even if permitted, may not represent a significant source of uplink interference and the interference level does not change abruptly over time.

The adoption of uplink scheduling brings along certain challenges, however. For example, according to the EUL provisions mentioned, individual mobile stations operating as packet data users subject to uplink scheduling transmit a Physical Dedicated Control Channel (DPCCH) signal when transmitting scheduled data and when not transmitting scheduled data, although the signal may be gated in the latter instance. A supporting base station thus receives a DPCCH signal for each scheduled user and uses the quality of that received signal as a basis for maintaining closed loop control of each user's uplink transmit power.

As is known, such power control usually includes an inner and outer power control loop for each user. The outer loop power control sets a received quality target based on the user's data rate, for example, and the inner loop power control generates up/down commands as needed, for increasing and decreasing the user's uplink transmit power as needed to maintain the received signal quality at the base station for that user at the quality target. Outer loop power control also adjusts the quality target based on a communication performance metric, such as data error rates.

Problematically, however, in a scheduled uplink environment, the received signal quality at the base station can vary dramatically for a given user in dependence on whether a given user is or is not engaged in a scheduled uplink data transmission. If the given user is engaged in a scheduled transmission at a very high rate, it is likely that no other scheduled users are causing any significant uplink interference. Thus, the other-user interference measured at the base station for the given user's signal will be low. On the other hand, the other-user interference measured at the base station for the given user's signal will be potentially large during times that the given user is not scheduled and one or more other users are transmitting uplink data.

As such, the measured signal quality at the base station for the given user may drop significantly when the given user ends a scheduled transmission. The known inner/outer loop power control mechanisms would thus “see” a significant negative change in the measured signal quality relative to the target, and would begin incrementally driving the given user's transmit power upward. However, inner loop power control operates in incremental fashion, e.g., each “up” command translates into a 1 dB or 2 dB step up in uplink transmit power.

Thus, inner loop power control, even with high rate command generation, will end up chasing the large observed drop in signal quality, and may not even stabilize (converge) before the next scheduled transmission by the given user. At that point, the measured signal quality for the given user may undergo a potentially large step change improvement for the reasons explained above, and the power control loop begins driving back in the other direction. This see-sawing of uplink power control causes, among other things, inefficiency and potential instability.

### SUMMARY

The teachings presented herein provide, among other things, improved power control stability and increased system capacity in a wireless communication network by adjusting quality targets used to generate uplink power control commands for mobile stations based on the scheduled statuses of those mobile stations. For example, in at least one embodiment presented herein, a base station implements a method wherein it raises the quality target for a given mobile station at the start of a scheduled uplink data transmission by that mobile station, and lowers the quality target at the end of the scheduled uplink data transmission.

The amounts by which the quality target is raised and lowered at the start and end of a scheduled uplink data transmission may be calculated as function of measured changes in other-user interference associated with the start and end. In any case, raising and lowering the quality target in this manner enables the base station's uplink power control process to converge (stabilize) faster at the transitions associated with the mobile station starting and ending a scheduled uplink data transmission.

As one example, the teachings herein are applied to the Enhanced UpLink (EUL) in a Wideband Code Division Multiple Access (WCDMA) network. In that context, the quality target (e.g., targeted Signal-to-Interference Ratio) for a given mobile station's Dedicated Physical Control Channel (DPCCH) signal is raised at the start of a scheduled data transmission via its Enhanced-Dedicated Physical Data Channel (E-DPDCH), and lowered at the end of the scheduled data transmission. Doing so prevents the power control loop implemented by the network for the mobile station from “chasing” the potentially dramatic changes in mobile-specific interference conditions that arise in a scheduled uplink environment.

Broadly, then, one embodiment of a method of controlling uplink transmit power for a mobile station operating with scheduled uplink data transmissions comprises generating uplink power control commands for the mobile station based on a quality target used to evaluate an uplink signal received from the mobile station, determining the mobile station's scheduled status, and adjusting the quality target based on the mobile station's scheduled status. Adjusting the quality target comprises, for example, raising the quality target at the start of scheduled uplink data transmissions by the mobile station and lowering the quality target at the end of scheduled uplink data transmissions by the mobile station.

In one embodiment, changes in measured other-user interference, which may be reflected in signal quality measurements made for the mobile station's uplink signal, are used to detect the start and end of scheduled transmissions. Further, in at least one embodiment, the measured changes are the basis for calculating the amounts by which to raise and lower the quality target at the start and end of the scheduled uplink data transmission. In another embodiment, scheduling information from a scheduling processor responsible for scheduling the mobile station is used to determine the start and end of scheduled uplink data transmissions by the mobile station.

In another embodiment, a base station circuit for controlling uplink transmit power for a mobile station operating with scheduled uplink data transmissions comprises a power control processor and a quality target processor. The power control processor is configured to generate uplink power control commands for the mobile station based on a quality target used to evaluate an uplink signal received from the mobile station, and the quality target processor is configured to determine the mobile station's scheduled status, and adjust the quality target based on the mobile station's scheduled status.

The above embodiments thus use lower signal quality targets for controlling a mobile station's uplink power during times when the mobile station is not actively engaged in a scheduled uplink data transmission and the other-user interference may be expected to be higher. That is, a lower quality target is used when the mobile station is not transmitting data in a scheduled transmission and it is likely that one or more other mobile stations may be actively engaged in scheduled uplink data transmissions. Conversely, such embodiments use higher signal quality targets for controlling the mobile station's uplink power during times when the mobile station is actively engaged in a scheduled uplink data transmission and the other-user interference may be expected to be lower. That is, a higher quality target is used when the mobile station is engaged in a scheduled transmission and it is likely that none or relatively few other mobile stations are simultaneously engaged in coincident scheduled uplink data transmissions.

According to teachings presented herein, the times when the mobile station is engaged in scheduled uplink data transmissions may be detected directly or indirectly. One example of indirect detection comprises dynamically measuring self-interference and other-user interference for the mobile station and determining whether the mobile station is in a scheduled uplink data transmission or between scheduled uplink data transmissions based on said dynamic measurements. One example of direct detection comprises receiving scheduling information from a scheduling processor responsible for scheduling the uplink data transmissions of the mobile station.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of one embodiment of a wireless communication network that includes a base station implementing improved power control for mobile stations operating in a scheduled uplink environment.

FIG. 2 is a logic flow diagram of one embodiment of processing logic for carrying out a method of improved power control for mobile stations operating in a scheduled uplink environment.

FIG. 3 is a plot of hypothetical quality target adjustments that may be used in improving power control for a mobile station operating in a scheduled uplink environment.

FIG. 4 is a block diagram of one embodiment of a base station circuit that improves power control for a mobile station operating in a scheduled uplink environment by adjusting signal quality targets based on the scheduled status of the mobile station.

FIG. 5 is a block diagram of another embodiment of a base station circuit that improves power control for a mobile station operating in a scheduled uplink environment by adjusting signal quality targets based on the scheduled status of the mobile station.

FIGS. 6 and 7 are example diagrams of relative types and amounts of interference experienced at a base station for a given mobile station's signal in a scheduled uplink environment.

FIG. 8 is a block diagram of another embodiment of a base station circuit that improves power control for a mobile station operating in a scheduled uplink environment by adjusting the quality target used for power controlling the mobile station based on the mobile station's scheduled status.

### DETAILED DESCRIPTION

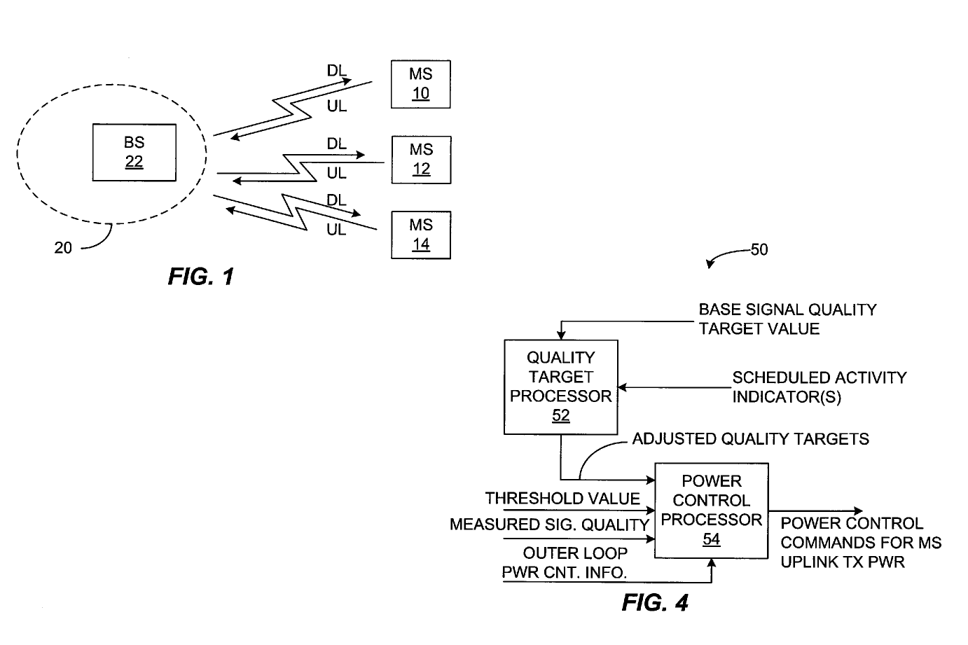

As a non-limiting example, FIG. 1 illustrates a number of mobile stations in communication with a supporting wireless communication network 20, which is presented in simplified form with the illustration of a single base station 22, e.g., a “NodeB” in a WCDMA-based implementation of the network 20. For further simplification, the drawing depicts only three mobile stations 10, 12, and 14, but it should be understood that a greater or lesser number of mobile stations may be supported by the base station 22.

In one or more embodiments, the mobile stations are high-rate users that transmit uplink data to the base station 22 on a scheduled basis. Scheduling the uplink data transmissions allows only one or a controlled number of mobile stations to transmit high-rate data on the uplink at any given scheduling time. Correspondingly, the base station 22 modifies the quality target used for controlling the uplink transmit power of a given mobile station when that mobile station (“user”) is scheduled for an uplink data transmission. In at least one embodiment, the quality target for a given mobile station, which may be expressed as a signal-to-interference ratio (SIR) target, is raised at the start of a scheduled uplink data transmission by the mobile station, and is lowered at the end of the transmission. According to the teachings herein, the raising and lowering may be accomplished by calculating a modification factor referred to herein as an “Activity Dependent SIR Target” (ADST) correction factor. As will be detailed, the modification factor may be computed based on measuring interference changes corresponding to the start and end of the scheduled transmission.

Regardless of the particular calculation approach, in one or more embodiments presented herein, the base station 22 raises the SIR target of a given mobile station for scheduled transmissions by that mobile station, and lowers the SIR target for times between those scheduled transmissions. Doing so increases uplink capacity through improved uplink transmit power control in scheduled transmission environments, such as those defined for EUL in Releases 6 and 7 of the WCMDA standards. Power control is improved by better stabilizing the uplink power control loop in scheduled environments with their potentially high variations in the amount and type of uplink interference. In one or more particular embodiments, the method also provides for a higher Dedicated Physical Control Channel (DPCCH) signal-to-interference ratio (SIR) during scheduled transmissions. That improvement in SIR is beneficial because it supports improved channel estimation at the base station 22, leading to correspondingly improved data throughputs.

Turning back to the drawing details, and using the mobile station 10 as an example, one sees that it has communication links with the base station 22 in the uplink (UL) and downlink (DL) directions. Thus, the base station 22 communicates with the mobile station 20 via one or more channels defined on the downlink, where such channels may be dedicated to the mobile station 10, shared with other mobile stations, or may be some mix of dedicated and shared channels. Similarly, the mobile station 10 communicates with the base station 22 via one or more channels defined on the uplink.

As a general proposition, and as is well understood in the art, one or more of the downlink and uplink channels operates with power control. For example, the mobile station 10 generates downlink power control commands for controlling the base station's transmit power on one or more downlink channel signals targeted to the mobile station 10. The mobile station 10 generates the downlink power control commands based on the quality at which it receives one or more of the downlink channel signals. Conversely, the base station 22 generates uplink power control commands for controlling the mobile station's transmit power on one or more uplink channel signals transmitted by the mobile station 10. The base station 22 generates the uplink power control commands based on the quality at which it receives one or more of the uplink channel signals.

As a further uplink detail, the mobile station 10 may operate on the uplink according to scheduling by the base station 22 (or by some other associated scheduling entity). For example, assuming that the network 20 is configured according to the provisions in Releases 6 and 7 of the 3GPP standard, e.g. HSUPA (High Speed Uplink Packet Data) and HSUPA Evolution, the mobile station 10 transmits high-rate data on the uplink using an Enhanced-Dedicated Physical Data Channel (E-DPDCH) signal at scheduled times as determined by a user scheduling process running in the base station 22. (Likewise, the other example mobile stations 12 and 14 also may transmit uplink data via their E-DPDCH signals according to user scheduling.)

In this example context, the mobile station 10 further transmits a Dedicated Physical Control Channel (DPCCH) signal, which the base station 22 uses to power control the scheduled uplink data transmissions by the mobile station 10 on the E-DPDCH. As such, the mobile station 10 transmits an E-DPDCH signal only during scheduled uplink data transmissions, but transmits its DPCCH signal regardless of whether an E-DPDCH transmission is active, although the DPCCH signal may be discontinuous or otherwise gated for interference and power consumption reasons. This transmission arrangement allows, among other things, the base station 22 to maintain the mobile station's uplink transmit power for the E-DPDCH at appropriate levels by monitoring the quality at which it receives the DPCCH signal transmitted by the mobile station. Such monitoring comprises, for example, measuring the SIR of the DPCCH signal as received and comparing it to the SIR quality target maintained at the base station 22 for the mobile station 10.

With such scheduling, at any given time, only one mobile station or a restricted number of mobile stations, is permitted to transmit high-rate data on the uplink at any given time. That constraint allows individual mobile stations to achieve higher data rates than would be achievable if all or a larger number of them were permitted to transmit at high power on the uplink. However, scheduling uplink transmission in this manner results in potentially dramatic changes in the individual interference conditions bearing on the signals received at the base station 22 for individual mobile stations. These potentially large changes in the amount and type of interference complicate uplink power control.

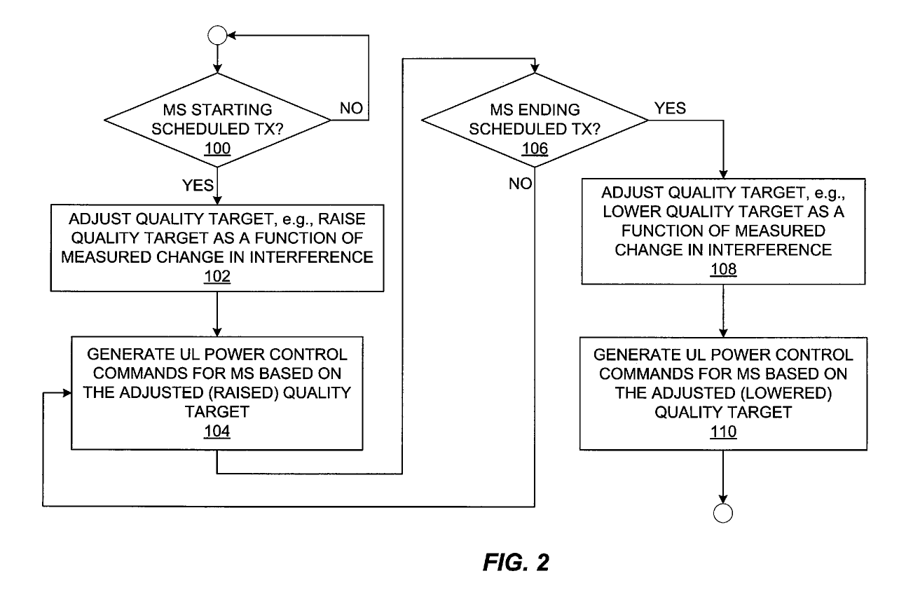

To that end, the base station 22 is configured to implement a method of controlling uplink transmit power for the mobile station 10 (or any of the other mobile stations alternatively or additionally). FIG. 2 illustrates one embodiment of the method, which may be implemented in hardware, software, or any combination thereof at the base station 22. For example, the base station 22 includes one or more general- or special-purpose microprocessors and associated memory/storage, and the method of FIG. 2 is implemented as a computer program product comprising program instructions for carrying out the illustrated processing.

It also should be understood that the processing of FIG. 2 may be a subset of other ongoing base station processing, and/or that other base station processing may run in parallel with the processing flow of FIG. 2. Further, the processing of FIG. 2 may be looped or otherwise repeated, and may be duplicated or otherwise extended to handle like processing in parallel for multiple mobile stations.

With the above qualifiers in mind, the example of processing of FIG. 2 begins with the assumption that the subject mobile station, e.g., mobile station 10, is not active in a scheduled uplink data transmission and therefore is operating with a certain signal quality target. The illustrated processing thus begins with determining whether the mobile station 10 is transitioning to the “active” condition (Block 100). “Active” in this sense means that the mobile station 10 is engaged in a scheduled uplink data transmission. By “engaged,” this disclosure means that the mobile station is in or otherwise beginning a scheduled uplink data transmission. As an example, the detection function illustrated in Block 100 comprises in one embodiment the detection of changing interference types/amounts as an indication that the mobile station 10 is transitioning from the inactive state (not engaged in a scheduled uplink data transmission) to the active state (engaged in a scheduled uplink data transmission), or vice-versa.

If at Block 100 it is detected that the mobile station is simply continuing in the inactive condition, processing continues with the existing signal quality target basis for power control generation. However, if the mobile station 10 is determined to be active, the base station 22 adjusts the quality target (Block 102). For example, the base station 22 may calculate the amount by which to raise the quality target based on measuring the change in interference (e.g., other-user interference) occurring at the start of the scheduled uplink transmission. In any case, the base station 22 generates uplink power control commands for the mobile station 10 based on the adjusted quality target (Block 104).

In more detail, in at least one embodiment, the base station raises the quality target at the start of the mobile station's scheduled transmission by computing an ADST correction factor and adding it to the signal quality target value existing at the inactive-to-active transition point.

This adjustment yields a raised or elevated quality target value for use by the base station 22 in power controlling the mobile station 10. Raising the quality target at the start of the scheduled transmission causes uplink power control at the base station 22 to drive or otherwise trend the uplink transmit power of the mobile station 10 upward, so that the received signal quality (at the base station 22) moves upward toward the raised signal quality target.

Processing during the active condition further includes sensing the transition back to the inactive condition—i.e., sensing whether the mobile station 10 is at the end of the scheduled uplink data transmission (Block 106). If not, processing continues with ongoing power control processing and continued monitoring for the end of the scheduled transmission (Blocks 104 and 106).

According to the above method, the base station 22 detects the start of a scheduled uplink data transmission by the mobile station 10, and, in response, it raises the quality target used by the base station 22 for power controlling the mobile station 10. Further, the base station 22 detects the end of the scheduled uplink data transmission and, in response, it lowers the quality target. Doing so improves operation of the base station's power control of the mobile station 10.

For example, it is expected that the base station 22 will perceive a potentially dramatic improvement in received signal quality for the mobile station 10 at the start of a scheduled transmission by the mobile station 10. Conversely, it is expected that the base station 22 will perceive a potentially dramatic degradation in received signal quality for the mobile station 10 at the end of a scheduled transmission by the mobile station 10. These potentially large changes in received signal quality arise because interference from other mobile stations likely will be low whenever the mobile station 10 is engaged in a scheduled transmission, and likely will be high at other times.

Thus, if the quality target used by the base station 22 for the mobile station 10 is not raised at the beginning of a scheduled transmission by the mobile station 10, the actual received signal quality may be much higher than the quality target. That difference would cause the base station 22 to begin driving the mobile station's uplink transmit power down. The downward power control action may not complete before the scheduled transmission ends. At that point, the actual received signal quality may suddenly drop, meaning that the base station 22 would begin driving the mobile station's uplink transmit power back up. Raising and lowering the quality target eliminates or at least moderates this behavior.

Therefore, a non-limiting advantage to raising the signal quality target when the mobile station 10 goes active is that other-user interference may be expected to decrease because none or a constrained number of other mobile stations are allowed to contribute anything significant to the uplink interference while the mobile station 10 is active. Thus, the higher quality target is more achievable and, additionally, driving toward a higher signal quality is helpful in that it maximizes data rate/throughput for the scheduled uplink data transmission. For example, setting a higher quality target for the DPCCH signal of given WCDMA mobile station provides for improved channel estimation and correspondingly improved demodulation performance for the E-DPDCH signal from that mobile station.

Similarly, a non-limiting advantage to lowering the signal quality target arises from the fact that other-user interference may be expected to rise when the mobile station 10 ends its scheduled transmission, because it is likely that another mobile station, e.g., mobile station 12 or 14, begins its own scheduled transmission at that point. (The mobile stations may take turns in sending high-rate data, thus when one transmits the others do not, or they transmit at such a low rate they do not interfere significantly with the scheduled mobile station's uplink data transmission.) Thus, the power control loop is not as severely “taxed” when the mobile station 10 becomes inactive if the signal quality target that drives power control is lowered upon going inactive.

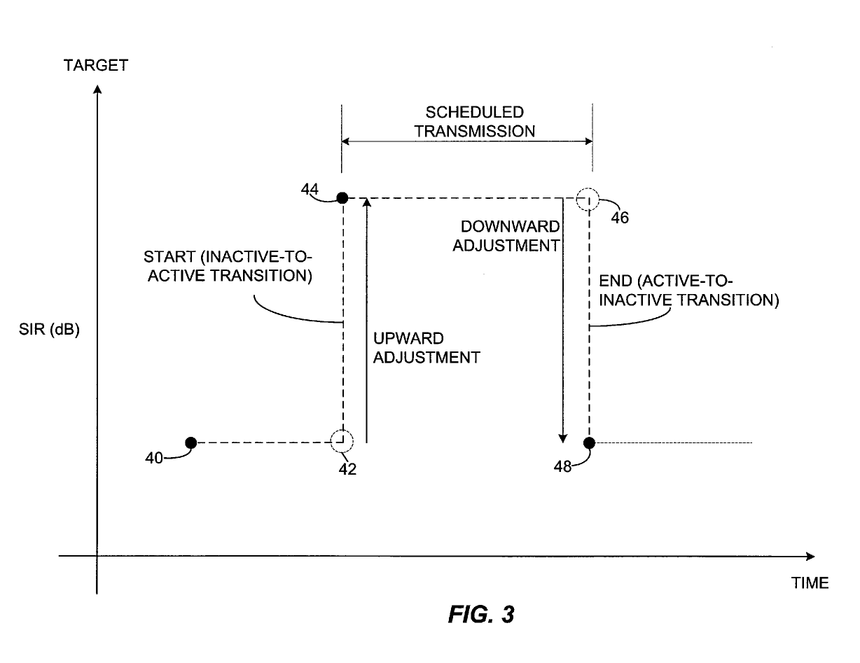

FIG. 3 offers a simplified diagram of the signal quality target adjustments resulting from the processing of FIG. 2. In FIG. 3, one sees an initial value for a signal quality target 40, corresponding to an inactive condition of the mobile station 10. At some later time, the mobile station 10 transitions to the active condition. At the transition point, the current signal quality target 42 may be used as the basis for computing a raised signal quality target 44. The value of the signal quality target 42 may be the same as that of the signal quality target 40 or it may differ by an amount related to any outer loop power control adjustments occurring between signal quality target 40 and signal quality target 42 on the time axis.

On that point, it should be noted that outer loop power control, if used by the base station 22, makes incremental adjustments to the quality target, rather than the larger adjustments contemplated herein for the start and end of a scheduled uplink data transmission. For example, incremental adjustment of the signal quality target via outer loop power control, which may be driven by data error rates for example, may be based on making 1 dB adjustments. Contrastingly, an embodiment of the teachings presented herein may raise the quality target for a given mobile station by 5 dB or even a 10 dB. Moreover, this raising of the quality target is made responsive to detecting transitions between active and inactive conditions of the mobile station 10, rather than responsive to data error rates or the like. Likewise, the downward adjustment at the end of the scheduled uplink data transmission may be large in comparison to incremental, outer-loop adjustments. Also, such downward adjustments are made responsive to detecting transitions from active to inactive conditions, e.g., such as occurring at or between the enhanced quality target 46 and the reduced quality target 48 depicted in FIG. 3.

Thus, with FIGS. 2 and 3 standing as non-limiting examples, those skilled in the art will appreciate that the teachings herein provide a method of controlling uplink transmit power for a mobile station operating with scheduled uplink data transmissions. Broadly, the method comprises adjusting quality targets as a function of detecting the scheduled statuses of mobile stations. For example, for a given mobile station, the base station 22 raises the quality target at the start of a scheduled uplink data transmission by that mobile station, and lowers it at the end of the transmission.

In one or more embodiments, the method includes detecting the start and end of scheduled uplink data transmissions. Such detection is based on, for example, dynamically measuring self-interference and other-user interference for the mobile station, and determining whether the mobile station is in a scheduled uplink data transmission (e.g., starting or ending) or between scheduled uplink data transmissions based on said dynamic measurements. In another embodiment, such detection is based on receiving scheduling information from a scheduler responsible for scheduling uplink data transmissions by the mobile station.

FIG. 4 illustrates an example base station circuit 50, which may be embodied within the base station 22, and which supports any one or more of the embodiments described immediately above and elsewhere herein. The base station circuit 50 may comprise hardware, software, or any combination thereof. As noted earlier herein, it may, for example, comprise a computer program product loaded or otherwise embodied in the base station 22 for execution by one or more special- or general-purpose microprocessors.

Regardless of the implementation details, the illustrated embodiment of the base station circuit 50 at least functionally comprises a quality target processor 52 that is configured to determine the scheduled status of mobile stations, and to adjust quality targets based on the scheduled statuses of the mobile stations. The base station circuit 50 further comprises a power control processor 54 that is configured to generate uplink power control commands for the mobile station of interest, e.g., mobile station 10, based on the adjusted quality targets.

The illustrated processors 52 and 54 also may perform the above functions for any number of mobile stations (e.g., mobile station 10, 12 and 14). Alternatively, the base station circuit 50 may include parallel implementations of such processors, at least in the functional processing sense, to support quality target adjustment and power control processing as taught herein, simultaneously for multiple mobile stations at the same time. Note that quality target adjustments generally are calculated on a mobile-specific basis, such that supporting multiple mobile stations in this manner involves computing individualized upward and downward quality target adjustments, as corresponding individual mobile stations begin and end scheduled uplink transmissions. Doing so allows the base station 22 to generate individualized uplink power control commands based on the individually adjusted quality targets corresponding to the different mobile stations being power controlled in this manner.

In more detail, the power control processor 54 generates up/down (or up/down/hold) power control commands for a mobile station, e.g., the mobile station 10, by measuring the received signal quality of an uplink signal transmitted by the mobile station 10, and comparing the received signal quality to the value of the quality target maintained by the base station circuit 50 for the mobile station 10.

If the measured signal quality is below the quality target, the power control processor 54 generates “up” power commands, causing the mobile station 10 to increase its uplink transmit power. If the measured signal quality is above the quality target, the power control processor 54 generates “down” power commands, causing the mobile station 10 to decrease its uplink transmit power. In a more sophisticated embodiment, the power control processor 54 may generate null or “no change” commands, depending upon whether the differences between the measured and target signal qualities lie within a threshold value, which may be provided as an input to the power control processor 54.

Further, it may be noted that outer loop or other power control processes may be running in the power control processor 54, or elsewhere within the base station 22, and that such processes may make incremental changes to the value of the quality target. However, those changes are apart from the adjustments made herein in response to determining the scheduled status of the mobile station.

With the above explanation of power control in mind, it will be appreciated that the quality target processor 52 is, in one or more embodiments, configured to determine the scheduled status of the mobile station 10, and to adjust the quality target used by the power control processor 54 for the mobile station 10, based on that scheduled status. For example, in one embodiment, the quality target processor 52 detects the start of a scheduled uplink data transmission by the mobile station 10, and calculates an amount by which to raise the current value of the quality target. That calculated amount, which may be expressed as the earlier described correction factor, may be added to the current value of the quality target to obtain an upwardly adjusted quality target provided to the power control processor 54 by the quality target processor 52. Similarly, the quality target processor 52 may provide the power control processor 54 with the correction factor, such that the power control processor 54 obtains the upwardly adjusted quality target by adding the correction factor to the current value of the quality target. (Here, the current value may be, for example, the value of the quality target existing immediately before detection of the start of the scheduled transmission.)

In similar fashion, the quality target processor 52 detects the end of a scheduled uplink data transmission by the mobile station 10, and calculates an amount by which to lower the current value of the quality target. That calculated amount, which may be expressed as the earlier described correction factor, may be subtracted from the current value of the quality target to obtain a downwardly adjusted quality target provided to the power control processor 54 by the quality target processor 52. Of course, the quality target processor 52 may provide the power control processor 54 with the correction factor, such that the power control processor 54 obtains the downwardly adjusted quality target by subtracting the correction factor from the current value of the quality target. (Here, the current value may be, for example, the value of the quality target existing immediately before detection of the end of the scheduled transmission.)

Thus, referring momentarily back to FIG. 3, it may be seen that one or more embodiments of the quality target processor 52 provide quality target adjustments at least at the transition points between inactive-to-active and active-to-inactive, which corresponds to those times when the mobile station 10 is beginning and ending a scheduled uplink data transmission. In this manner, the quality target used by the power control processor 54 for controlling the uplink transmit power of a given mobile station is raised at the start of scheduled uplink data transmissions by that mobile station, and is lowered at the end of such transmission. Again, it is noted that these adjustments are based on determining the scheduled status of the mobile station, and are not the ongoing, incremental quality target adjustments, if any, that may be made by outer-loop power control at the base station 22.

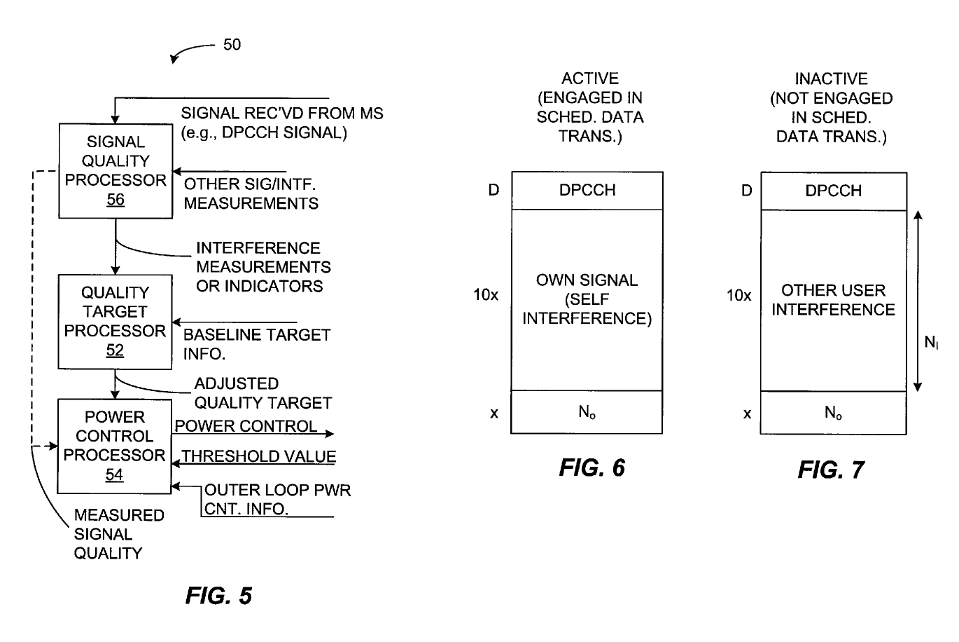

FIG. 5 illustrates one embodiment where the base station circuit 50 includes or is communicatively coupled with a signal quality processor 56. The signal quality processor 56 is configured to dynamically measure self-interference and other-user interference for the mobile station 10. Of course, there may be multiple signal quality processors 56 for measuring interference for multiple mobile stations operating in the scheduled uplink environment, or the signal quality processor 56 may be configured to perform interference measurements for multiple mobile stations.

Regarding mobile station 10 as a specific example, the base station circuit 50, e.g., the quality target processor 52, is configured to determine whether the mobile station 10 is in a scheduled uplink data transmission or between scheduled uplink data transmissions based on the dynamic interference measurements provided by the signal quality processor 56. Thus, this embodiment of the base station circuit 50 senses or otherwise recognizes whether the mobile station 10 is engaged in a scheduled uplink data transmission based on evaluating interference conditions. For example, it may detect the changes in other-user interference characteristically occurring at the start and end of a scheduled uplink data transmission by the mobile station 10 as a basis for detecting the start and end. (These measured changes also may be used to calculate the amounts by which to raise and lower the quality target at the start and end, respectively.)

To appreciate such power-control operations, consider a generalized scenario where a first mobile station being supported on the uplink by the base station 22 is a first packet data user, denoted as “UPD_1.” When this first packet data user is transmitting, the received interference at the base station 22 for the first user's uplink (control) signal includes residual self-interference (I_{RSI}), other-user interference (I_{OUI(coincident)}) caused by other packet data users transmitting simultaneously with the first packet data user, and background/thermal noise (N_{O}). Note that I_{OUI(coincident)} may be further specified as comprising two components: other-user interference arising from other users transmitting in the same cell (i.e., intra-cell interference), and other-user interference arising from other users transmitting in neighboring cells (i.e., inter-cell interference).

On the other hand, when the first packet data user is not active, the interference for the first packet data user at the base station 22 typically includes other-user interference arising from other users that are allowed to transmit uplink data when the first data user is not transmitting, which may be denoted as I_{OUI(non-coincident)}. That is, although the first packet data user is not transmitting scheduled data, the base station 22 still measures the signal quality of, for example, the DPCCH being transmitted by the first packet data user. The scheduled data transmissions of other packet data users thus interfere with the reception of the DPCCH or other monitored signal from the first packet data user. Additionally, the interference seen at the base station 22 for the first packet data user at times when the first packet data user is not actively transmitting scheduled uplink data includes back ground noise and front-end noise (N_{O}).

Thus, for the scenario where a given packet data user transmits scheduled uplink data on a E-DPDCH and transmits associated control information on a DPCCH, which is transmitted to the base station 22 even when the E-DPDCH signal is not being transmitted and is used by the base station 22 for power control, one may express the active state SIR of the user's DPCCH signal at the base station 22 as:

$$SIR ( active ) = \frac{{P}_{DPCCH}}{( {I}_{RSI} + {I}_{OUI ( coincident )} + {N}_{o} )} . \qquad Eq . ( 1 )$$

In Eq. (1), “P_{DPCCH}” represents the received signal power of the DPCCH from the packet data user. Conversely, when the given packet data user is not active (not engaged in a scheduled uplink data transmission), the corresponding SIR measurement for the DPCCH signal at the base station 22 may be computed as:

$$SIR ( inactive ) = \frac{{P}_{DPCCH}}{( {I}_{OUI ( non \text{-} coincident )} + {N}_{o} )} . \qquad Eq . ( 2 )$$

Again, the “non-coincident” nomenclature identifies the scheduled uplink data transmissions of other users that happen at times other than the scheduled uplink data transmission times of the given packet data user that is the subject of this example.

From Eq. (1) and Eq. (2), one may discern that the teachings presented herein are particularly advantageous when the interference terms I_{OUI(coincident)} and I_{OUI(non-coincident)} differ significantly. That is, compensating or otherwise adjusting the SIR target for the DPCCH signal from a given packet data user as a function of whether or not that given packet data user is active in a scheduled uplink data transmission yields more significant benefits when the signal interference “picture” changes more dramatically between times when that user is active and when that user is inactive.

Such conditions may occur frequently in actual operation. For example, for a given packet data user, the value of I_{OUI(coincident)} at the base station 22 generally will be low if no other users are scheduled to transmit on the uplink at the same time as the given user. Conversely, the value of I_{OUI(non-coincident)} for the given user may be high if one or more other users conduct their own respectively scheduled uplink data transmissions at times when the given user is not scheduled.

FIG. 6 provides a simplified, hypothetical illustration of the case where other-user interference coincident with a scheduled transmission by the mobile station 10 is zero or negligibly small, i.e., I_{OUI(coincident)} is not considered. For this case, the “stack” illustrated in FIG. 6 indicates that the total interference bearing on the base station's reception of the DPCCH signal includes a dominant residual self-interference component arising from the mobile station's own signal, i.e., I_{RSI}, and a much smaller noise/thermal component, i.e., N_{O}.

Assuming a dB basis, if No constitutes “X” amount of the total interference and I_{RSI} constitutes 10 that amount (10X), it would appear that the total interference is 11X, thus yielding an SIR at the base station 22 for the mobile station's DPCCH signal of D/11X, where “D” denotes the received signal power for the DPCCH at the base station 22. However, because of signal coding orthogonality, the I_{RSI} may be discounted, and the effective SIR is D/X.

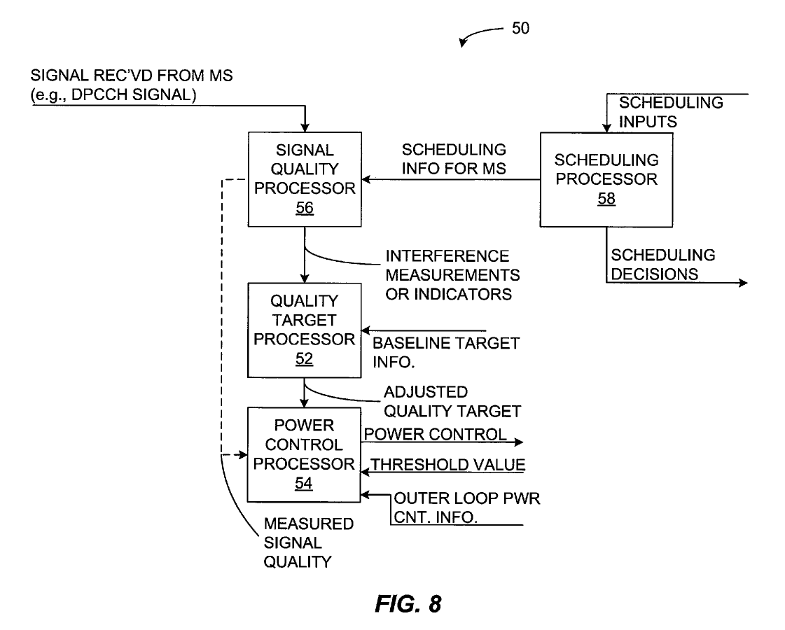

Conversely, FIG. 7 illustrates the case where the mobile station 10 is not active, and one or more other users are engaged in scheduled uplink data transmissions. The “stack” of FIG. 7 shows that other-user interference, i.e., I_{OUI}(non-coincident), constitutes 10X of the total interference and must be considered in the SIR calculation. Doing so yields an effective SIR at the base station 22 for the DPCCH signal from the mobile station 10 of D/11X.

Thus, these example figures illustrate that the received DPCCH SIR for the mobile station 10 during the times between scheduled uplink data transmissions by the mobile station 10 can be about one tenth of the received DPCCH SIR during its scheduled transmissions. Hence, when beginning a scheduled transmission, there generally will be a large step in the received DPCCH SIR, as measured by the base station 22. In the example above, the received DPCCH SIR as measured by the base station 22 would increase about 10 dB at the start of the scheduled transmission by the mobile station 10. Note that a similar step-change problem in measured DPCCH SIR occurs at the end of the scheduled transmission.

Broadly, then, the signal quality processor 56 can be configured to measure signal quality for the uplink control signal of a given mobile station subject to uplink scheduling by measuring interference bearing on the reception of that uplink signal at the base station 22, and correspondingly determining a signal-to-interference ratio (SIR) of the received uplink control signal. Alternatively, the signal quality processor 56 simply provides the relevant interference measurements, e.g., ongoing, dynamic interference measurements, and the target quality processor 52 performs the SIR estimations.

In either case, the signal quality determination during a scheduled uplink data transmission may be based on measuring residual self-interference arising from the mobile station's own transmission, other-user interference arising from any coincidently scheduled uplink data transmissions by other mobile stations, and background interference. Further, the signal quality determination (i.e., control channel SIR) for times between scheduled uplink data transmissions can be based on measuring other-user interference arising from non-coincidently scheduled uplink transmissions by other mobile stations, and background interference.

It should be understood, then, that the teachings presented herein address, among other things, the stability issues and other problems that would otherwise arise from the base station's inner loop power control algorithm “chasing” these large swings in measured DPCCH SIR. To avoid those and other problems, the following equations provide a specific but non-limiting example of adjusting the SIR target of a given user upward responsive to that user starting a scheduled uplink transmission.

To provide a more detailed but still non-limiting example, the below equations represent the case where a given mobile station, e.g., mobile station 10, is beginning a scheduled uplink transmission on its E-DPDCH. As such, the base station 22 adjusts the value of the quality target used for evaluating its reception of the mobile station's DPCCH upward at the start of the scheduled transmission and downward at the end of the scheduled transmission.

Thus, as a specific example of computing an ADST correction factor for adjusting the (DPCCH) signal quality target of the mobile station 10 at the beginning a scheduled uplink data transmission, the SIR target used for uplink power control of the mobile station's DPCCH signal can be adjusted at the start of the scheduled transmission as,

$$SIR\_target ( start\_adjustment ) dB = SIR\_target ( current ) dB + 10 log ( \frac{{P}_{DPCCH}}{{I}_{RSI} + {I}_{OUI ( coincident )} + {N}_{o}} ) - 10 log ( \frac{{P}_{DPCCH}}{{I}_{OUI ( non \text{-} coincident )} + {N}_{o}} ) . \qquad Eq . ( 3 )$$

In Eq. (3), the “P_{DPCCH}” is the power or signal strength of the mobile station's DPCCH signal as received at the base station 22 before the start of the scheduled transmission. Further, the “current” value of the SIR target may simply be the value of the SIR target being used for the mobile station 10 prior to detecting the start of the scheduled uplink data transmission. As might be guessed, then, the “start_adjustment” value of the SIR target represents the calculated value to which the current SIR target will be raised, responsive to detecting the start of the scheduled uplink data transmission.

Eq. (3) can be simplified as,

SIR_target (start_adjustment) dB=SIR_target (current) dB+I_{OUI(non-coincident)} dB−I_{OUI(coincident)} dB−I_{RSI} dB. Eq. (4)

It should be noted with respect to Eq. (3) and Eq. (4), that the non-coincident measure of interference represents, for example, the last measure of other-user interference for the mobile station prior to detecting the start of the mobile station's scheduled uplink data transmission, although that value itself may represent an averaged measurement spanning some duration of time before the start of the scheduled uplink data transmission. Conversely, the coincident measure of interference in these two equations represents, for example, an updated measurement of other-user interference that is taken after the detected start of the scheduled uplink data transmission.

Thus, as a further simplification, Eq. (4) can be expressed in terms of the measured change or difference (“delta”) occurring at the start of any given scheduled uplink data transmission. That is, Eq. (4) can be expressed in terms of how the other-user interference changes when the mobile station 10 goes from inactive to active. With that, Eq. (4) becomes,

SIR_target (start_adjustment) dB=SIR_target (current) dB+ΔI_{OUI} dB−I_{RSI} dB. Eq. (5)

Obviously, the ΔI_{OUI} represents the difference between I_{OUI(non-coincident)} as measured (and remembered) before the start of the scheduled uplink data transmission and I_{OUI(coincident)} as measured at the start of the scheduled uplink data transmission. Those skilled in the art will appreciate that “at” does not necessarily denote the exact start of the scheduled uplink data transmission, but rather may generally denote the point at which the scheduled start is detected by way of interference measurements, for example.

Thus, by defining the ADST correction factor, ADST_{cf}, as ΔI_{OUI} dB−I_{RSI} dB, one may express the SIR target adjustment equation as,

SIR_target (start_adjustment) dB=SIR_target (current) dB+ADST_{cf} Eq. (6)

Eq. (6) represents the raising of the SIR target used by the base station 22 for the mobile station 10 (or individually, for any given number of mobile stations), responsive to the base station 22 detecting the start of a scheduled uplink data transmission by the mobile station 10.

In some cases the ADST correction factor calculation can be further simplified by assuming that I_{RSI}=0, if the mobile station 10 begins the scheduled transmission at a low rate. That approach is sensible because the residual self interference will be lower at the lower transmit power used for lower-rate transmission, and in a scheduled uplink transmission environment, it is likely that the mobile station 10 is not transmitting data at all, or is transmitting data at a low rate, prior to beginning a scheduled uplink transmission of data.

As another example simplification, the quality target processor 52 or other entity within the base station 22 may set I_{OUI(coincident)}=0, if the mobile station 10 begins its scheduled transmission at a high rate. That simplification is sensible based on the assumption that no other high-rate (significant interferers) will be permitted to conduct scheduled transmissions coincident with this particular scheduled transmission by the mobile station 10. Thus, in accordance with one or more embodiments presented herein, the target adjustment calculations may be simplified, based on knowledge of the mobile station's transmit rates, or at least the relative ranges of rates (e.g., below or above some defined low and high rate thresholds) before and after starting a scheduled uplink data transmission.

Of course, where the base station circuit 50 has direct knowledge of scheduling decisions, it need not make scheduling assumptions or guesses. Rather, it can make these and other simplifications as appropriate, based on direct knowledge of scheduling. FIG. 8 illustrates an embodiment of the base station circuit 50, wherein it includes or is communicatively coupled with a scheduling processor 58. The illustrated scheduling processor 58 is responsible for scheduling uplink data transmissions by the mobile stations, e.g., mobile stations 10, 12, and 14. Thus, with respect to any given mobile station subject to uplink scheduling, the base station circuit 50 is configured to detect the times corresponding to the scheduled uplink data transmissions and the times between the scheduled uplink data transmissions based on receiving scheduling information from the scheduling processor. More particularly, the base station circuit 50 can, in one or more embodiments, detect the start and end of scheduled uplink data transmissions by individual mobile stations, based on detecting changes in measured interference for the uplink (control) signals received from those mobile stations. Additionally, or alternatively, the base station circuit 50 detects the start and end of scheduled uplink data transmissions by individual mobile stations based on scheduling information received from an associated scheduling processor responsible for scheduling the uplink data transmissions of those mobile stations.

Thus, whether directly or indirectly detecting the scheduled transmissions for a given mobile station, the base station circuit 50 provides corresponding signal quality target adjustments at the starting/ending transitions of those scheduled transmissions. Broadly, the quality target processor 52 of the base station circuit 50 is configured in one or more embodiments to calculate an amount by which to raise the current signal quality target at the start a given scheduled uplink data transmission. That is, the base station circuit 50 raises the signal quality target for a subject mobile station by adjusting the prior signal quality target value that was in use for the subject mobile station before the scheduled uplink data transmission. That upward adjustment may, in one or more embodiments, be calculated as an amount related to a measured difference in signal quality for a control signal (e.g., the PDCCH) received from the subject mobile station before and after it begins the given scheduled uplink data transmission. (In a general sense, the adjustment may be based on the measured change in other-user interference occurring at the start of the scheduled uplink data transmission. In at least one embodiment, that change is evaluated by evaluating the change in received signal quality for the uplink control signal received from the subject mobile station, which is driven at least to some extent by the change in other-user interference occurring at the transition from inactive to active by the subject mobile station.)

Further, the quality target processor 52 is configured in one or more embodiments to calculate the reduced signal quality target for use after the given scheduled uplink data transmission by adjusting the value of the signal quality target at the end of the scheduled transmission downward by an amount related to a measured difference in signal quality for the control signal received from the mobile station before and after ending the given scheduled uplink data transmission. Alternatively, the quality target processor 52 may simply revert back to the reduced quality target in use immediately prior to the start of the scheduled transmission. That is, in one embodiment, the base station circuit 50 may remember the value of the quality target of a given mobile station at a time just before that mobile station was detected as starting a scheduled uplink data transmission, and it simply may drop the quality target back to that remembered value responsive to detecting the end of the scheduled uplink data transmission.

Regardless, such as shown in FIG. 5, in at least one embodiment the base station circuit 50 includes a signal quality processor 56 that is configured to measure signal quality for a control signal received from the mobile station during and between the scheduled uplink data transmissions. With that configuration, the quality target processor 52 is, in one or more embodiments, configured to calculate the amounts by which to raise and lower the quality targets in use at the base station 22 for individual mobile stations, based on changes in the measured signal quality associated with beginning and ending scheduled uplink data transmissions by those mobile stations. An alternative, as was shown in FIG. 8, is to provide the target quality processor 52 with uplink scheduling information from the scheduling processor 58, such that the base station circuit 50 is explicitly signaled regarding the start and end of scheduled uplink data transmissions by individual mobile stations. (The endings may be explicitly signaled, or simply determined based on information about the scheduled durations of such transmissions.)

Turning to specific but non-limiting details relating to quality target adjustment at the end of a scheduled transmission, the base station 22 can take a number of different approaches to lowering the signal quality target for a mobile station that is ending a scheduled uplink data transmission. As one example mentioned earlier herein, the base station 22 may simply remember the prior “SIR_target (current)” from Eq. (3) corresponding to the quality target in use at the base station 22 for the mobile station prior to the beginning of the scheduled transmission. In other words, the base station 22 may change may simply fall back to the prior reduced quality target.

An alternative approach is to assume that the base station's power control of the mobile station's DPCCH signal converged during active transmission. That is, the power control commands generated by the power control processor 54 during the scheduled transmission interval incrementally drove the transmit power of the mobile station 10 to the level needed to maintain the received SIR of the DPCCH signal from the mobile station at the raised quality target in use during the scheduled uplink data transmission.

Assuming power control convergence during the scheduled transmission, the enhanced SIR target in use by the base station 22 at the end of the mobile station's scheduled transmission may be expressed as,

$$SIR\_target ( current ) dB = 10 log 10 \cdot ( \frac{{P}_{DPCCH}}{{I}_{RSI} + {I}_{OUI ( coincident )} + {N}_{o}} ) . \qquad Eq . ( 7 )$$

Here, the “current” value represents the raised value of the quality target at the end of the scheduled transmission, e.g., immediately before the end. Thus, an example expression for calculating the lowered quality target to use after the end of the scheduled transmission is given as,

$$SIR\_target ( end\_adjustment ) dB = 10 log 10 \cdot ( \frac{{P}_{DPCCH}}{{I}_{OUI ( non \text{-} coincident )} + {N}_{o}} ) . \qquad Eq . ( 8 )$$

Comparing Eq. (4) and Eq. (8) for example, one sees that at least one embodiment of the base station circuit 50 is configured to calculate the amount by which to raise the signal quality target for a given mobile station at the start of a scheduled uplink data transmission by that mobile station as a function of the measured change in other-user interference occurring at the start. Similarly, such embodiments of the base station circuit 50 may be configured to calculate the amount by which to lower the signal quality for that mobile station at the end of the scheduled transmission as a function of the measured change in other-user interference occurring at the end.

As a further example of applying the signal quality target adjustment teachings presented herein to a EUL/WCDMA context, the base station 22 may be assumed to perform SIR measurement for uplink power control of, e.g., the mobile station 10, based on per-slot measurements. “Slot” measurements in this sense denote measurements made within the defined slot time frames comprising the uniformly repeating WCDMA frame intervals. (Nominally, one such frame spans 10 ms, and each frame comprises 15 slots. E-DPDCH transmission spans one or several Time Transmission Intervals (TTI). Each TTI length is 2 ms or 10 ms.)

During a scheduled transmission by the mobile station 10, the base station 22 performs supporting SIR measurements in each slot based on the following expression:

$$SIR\_target ( current ) dB = ( \frac{{P}_{DPCCH}}{{I}_{OUI ( coincident )}} ) dB , \qquad Eq . ( 9 )$$

where the P_{DPCCH} and I_{OUI(coincident)} measurements are updated in each slot. Conversely, when the mobile station 10 is not engaged in a scheduled transmission, uplink power control should operate on just P_{DPCCH}. The underlying assumption for this simplified power control approach is that the interference from other users with respect to the mobile station 10 is constant during the inactivity period, i.e., during the intervals between scheduled uplink data transmissions by the mobile station 10. The target P_{DPCCH} should be the power of the DPCCH that was received before going into inactive mode. For a long inactivity period, a new measure of the received power of the DPCCH signal from the mobile station 10 can be taken at selected time instants and filtered using previous measurements.

In yet another embodiment, the signal quality target adjustment method presented herein involves averaging interference estimates over multiple slots. This embodiment addresses situations when the mobile user is in the active or non-active state for more than one TTI. These interference estimates are the ones previously identified as the dynamic interference measurements made on a mobile-specific basis relating to the received signal quality at the base station 22 for given mobile stations. Averaging the interference measurements provides a better estimate of the interference conditions for receiving signals from the mobile station of interest, assuming of course that the interference conditions are not changing significantly within the averaging window.

One example of such averaging is to use the current and previous slot estimates for the interference measurements, assuming that the mobile station is in the same status in both slots. That is, assuming the mobile station remains in either the active or non-active modes over the prior and current slots, interference estimation may be improved by averaging interference estimates across those two slots. If the mobile station is in the non-active or inactive mode, i.e., not engaged in a scheduled uplink data transmission, an example averaging calculation is given as,

$$\begin{matrix}{I}_{OUI} = \frac{{I}_{OUI ( non \text{-} coincident ) , k - 1} + {I}_{OUI ( non \text{-} coincident ) , k}}{2} , \\ and & Eq . ( 10 ) \\ {N}_{o} = \frac{{N}_{o , k - I} - {N}_{o , k}}{2} , & Eq . ( 11 )\end{matrix}$$

where “k” indicates the current slot index and “k−1” indicates the prior slot index. Of course, averaging may be carried over multiple slots, but averaging across active-to-inactive and inactive-to-active transitions generally should be avoided.

With all of the above in mind, those skilled in the art will appreciate that the teachings herein provide a method and apparatus for adjusting the received signal quality target used by the base station 22 for power controlling a mobile station operating with scheduled uplink transmissions. By using a quality target adjustment factor, such as the ADST correction factor explained herein, the base station 22 provides smoother, more stable uplink power control for the widely varying interference conditions arising in a scheduled uplink environment.

More particularly, the base station method and apparatus presented herein raise the signal quality target when a given mobile station starts a scheduled uplink data transmission and lower the signal quality target at the end of that scheduled transmission. In so doing, the base station's uplink power control loop for the given mobile station is not forced to respond so aggressively to the step-changes in other-user interference that likely arise at the start and end of scheduled transmissions. Such changes arise in a scheduled uplink transmission environment because one or more other mobile stations generally are ending and starting, respectively their own scheduled uplink data transmissions at the start and end of the given mobile station's scheduled uplink data transmission. Similarly, power control and throughput (through better channel estimation) are improved by raising the signal quality target used by the base station 22 for the given mobile station when that given mobile station begins a scheduled uplink data transmission.

Thus, the foregoing description and the accompanying drawings represent non-limiting examples of the methods and apparatus taught herein for predictive link adaptation. As such, the present invention is not limited by the foregoing description and accompanying drawings. Instead, the present invention is limited only by the following claims and their legal equivalents.

What is claimed is:

1. A method in a wireless communication network of controlling uplink transmit power for a mobile station operating with scheduled uplink data transmissions, the method comprising:
generating uplink power control commands for the mobile station based on a quality target used to evaluate an uplink signal received from the mobile station;
determining the mobile station's scheduled status; and
adjusting the quality target based on the mobile station's scheduled status.

2. The method of claim 1, wherein adjusting the quality target based on the mobile station's scheduled status comprises raising the quality target at the start of scheduled uplink data transmissions by the mobile station and lowering the quality target at the end of scheduled uplink data transmissions by the mobile station.

3. The method of claim 2, wherein, for a given scheduled uplink data transmission by the mobile station, raising the quality target comprises measuring the change in other-user interference occurring at the start of the given scheduled uplink data transmission and calculating an amount by which to increase the quality target as a function of the measured change in other-user interference.

4. The method of claim 3, wherein lowering the quality target at the end of the given scheduled uplink data transmission comprises measuring the change in other-user interference occurring at the end of the given scheduled uplink data transmission and calculating an amount by which to decrease the quality target as a function of the measured change in other-user interference.

5. The method of claim 3, wherein lowering the quality target at the end of the given scheduled uplink data transmission comprises dropping the quality target back to a value in use before the quality target was raised at the start of the given scheduled uplink data transmission.

6. The method of claim 1, wherein determining the mobile station's scheduled status comprises detecting the start and end of scheduled uplink data transmissions by the mobile station.

7. The method of claim 6, wherein detecting the start and end of scheduled uplink data transmissions by the mobile station comprises dynamically measuring self-interference and other-user interference bearing on reception of the uplink signal from the mobile station, and determining whether the mobile station is in a scheduled uplink data transmission or between scheduled uplink data transmissions based on said dynamic measurements.

8. The method of claim 1, wherein determining the mobile station's scheduled status comprises receiving scheduling information from a scheduler responsible for scheduling uplink data transmissions by the mobile station.

9. The method of claim 1, wherein the uplink signal is an uplink control channel signal transmitted by the mobile station during and between the scheduled uplink data transmissions, and wherein adjusting the quality target based on the mobile station's scheduled status comprises increasing the quality target at the start of a scheduled uplink data transmission by an amount calculated from a change in received signal quality measured for the uplink control channel signal at the start of the scheduled uplink data transmission.

10. The method of claim 9, wherein adjusting the quality target based on the mobile station's scheduled status further comprises decreasing the quality target at the end of the scheduled uplink data transmission by an amount calculated from a change in received signal quality measured for the uplink control channel signal at the end of the scheduled uplink data transmission.

11. The method of claim 1, wherein the uplink signal comprises an uplink control channel signal that is transmitted by the mobile station during and between the scheduled uplink data transmissions, and wherein generating uplink power control commands for the mobile station comprises measuring received signal quality for the uplink control channel signal, comparing the received signal quality to the quality target, and generating the uplink power control commands for transmission to the mobile station based on said comparison.

12. The method of claim 11, wherein measuring signal quality for the uplink control channel signal comprises determining a signal-to-interference ratio (SIR) of the uplink control channel signal during the scheduled uplink data transmissions by the mobile station based on measuring residual self-interference arising from the mobile station's own transmission, other-user interference arising from coincidently scheduled uplink data transmissions by other mobile stations, and background interference, and determining the SIR of the uplink control channel signal during times between the scheduled uplink data transmissions by the mobile station based on measuring other-user interference arising from non-coincidently scheduled uplink transmissions by other mobile stations, and background interference.

13. A base station circuit for controlling uplink transmit power for a mobile station operating with scheduled uplink data transmissions, the base station circuit comprising:
a power control processor configured to generate uplink power control commands for the mobile station based on a quality target used to evaluate an uplink signal received from the mobile station; and
a quality target processor configured to determine the mobile station's scheduled status, and adjust the quality target based on the mobile station's scheduled status.

14. The base station circuit of claim 13, wherein the base station circuit is configured to adjust the quality target based on the mobile station's scheduled status by raising the quality target at the start of scheduled uplink data transmissions by the mobile station and lowering the quality target at the end of scheduled uplink data transmissions by the mobile station.

15. The base station circuit of claim 14, wherein, for a given scheduled uplink data transmission by the mobile station, the base station circuit is configured to raise the quality target by measuring the change in other-user interference occurring at the start of the given scheduled uplink data transmission and calculating an amount by which to increase the quality target as a function of the measured change in other-user interference.

16. The base station circuit of claim 15, wherein the base station circuit is configured to lower the quality target at the end of the given scheduled uplink data transmission by measuring the change in other-user interference occurring at the end of the given scheduled uplink data transmission and calculating an amount by which to decrease the quality target as a function of the measured change in other-user interference.

17. The base station circuit of claim 15, wherein the base station circuit is configured to lower the quality target at the end of the given scheduled uplink data transmission by dropping the quality target back to a value in use before the quality target was raised at the start of the given scheduled uplink data transmission.

18. The base station circuit of claim 13, wherein the base station circuit is configured to determine the mobile station's scheduled status by detecting the start and end of scheduled uplink data transmissions by the mobile station.

19. The base station circuit of claim 18, wherein the base station circuit is configured to detect the start and end of scheduled uplink data transmissions by the mobile station by dynamically measuring self-interference and other-user interference bearing on reception of the uplink signal from the mobile station, and determining whether the mobile station is in a scheduled uplink data transmission or between scheduled uplink data transmissions based on said dynamic measurements.

20. The base station circuit of claim 18, wherein the base station circuit includes or is operatively associated with a scheduling processor responsible for scheduling uplink data transmissions by the mobile station, and wherein the base station circuit is configured to determine the start and end of scheduled uplink data transmissions based on information received from the scheduling processor.

21. The base station circuit of claim 13, wherein the uplink signal is an uplink control channel signal transmitted by the mobile station during and between the scheduled uplink data transmissions, and wherein the base station circuit is configured to adjust the quality target based on the mobile station's scheduled status by increasing the quality target at the start of a scheduled uplink data transmission by an amount calculated from a change in received signal quality measured for the uplink control channel signal at the start of the scheduled uplink data transmission.

22. The base station circuit of claim 21, wherein the base station circuit is further configured to adjust the quality target based on the mobile station's scheduled status by decreasing the quality target at the end of the scheduled uplink data transmission by an amount calculated from a change in received signal quality measured for the uplink control channel signal at the end of the scheduled uplink data transmission.

23. The base station circuit of claim 13, wherein the uplink signal is an uplink control channel signal that is transmitted by the mobile station during and between the scheduled uplink data transmissions, and wherein the base station circuit includes or is operatively associated with a signal quality processor that is configured to measure received signal quality for the uplink control channel signal, and wherein the power control processor is configure to generate the uplink power control commands for transmission to the mobile station based on comparing the received signal quality to the quality target.

24. The base station circuit of claim 23, wherein the signal quality processor is configured to measure signal quality for the uplink control channel signal by determining a signal-to-interference ratio (SIR) of the uplink control channel signal during the scheduled uplink data transmissions by the mobile station based on measuring residual self-interference arising from the mobile station's own transmission, other-user interference arising from coincidently scheduled uplink data transmissions by other mobile stations, and background interference, and determine the SIR of the uplink control channel signal during times between the scheduled uplink data transmissions by the mobile station based on measuring other-user interference arising from non-coincidently scheduled uplink transmissions by other mobile stations, and background interference.

25. A method in a wireless communication network of controlling uplink transmit power for a mobile station operating with scheduled uplink data transmissions, the method comprising:
generating uplink power control commands for the mobile station based on a quality target used to evaluate an uplink control channel signal transmitted by the mobile station whether it is or is not engaged in a scheduled uplink data transmission;
raising the quality target responsive to detecting the start of a scheduled uplink data transmission by the mobile station; and
lowering the quality target responsive to detecting the end of the scheduled uplink data transmission by the mobile station.
